(19) United States
(12) Patent Application Publication
(10) Pub. No.: US 2004/0184257 A1
(43) Pub. Date: Sep. 23, 2004

(54) Surface light source unit with scatter enhancing regions

(76) Inventor: Chuan-De Huang, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/768,271

(22) Filed: Jan. 29, 2004

(30) Foreign Application Priority Data
Jan. 29, 2003 (TW) 92101911

(51) Int. Cl. F21V 7/04

(52) U.S. Cl. 362/31

(57) ABSTRACT

A surface light source unit (3) providing illumination for a liquid crystal display panel includes a light guide plate (32) and a plurality of point light sources (31). The light guide plate includes a light incidence surface (323) adjacent to the point light sources, a top emission surface (321) perpendicular to the light incidence surface, a bottom surface (322) opposite to the top emission surface, and a plurality of side surfaces (324). A plurality of diffusion dots (36) is formed on the bottom surface, and a plurality of scatter enhancing regions (325) is defined on the bottom surface adjacent to the light incidence surface. The scatter enhancing regions enable the surface light source unit to provide highly uniform illumination.

### BACKGROUND OF THE INVENTION

1. Field of the Invention

The present invention relates to a surface light source unit typically used in a liquid crystal display (LCD), and especially to a surface light source unit with highly uniform illumination.

2. Description of Prior Art

Recently, color liquid crystal display devices have been widely used in various applications, such as in portable personal computers, liquid crystal display televisions, video built-in type liquid crystal televisions, etc. A conventional liquid crystal display device comprises a back light unit and a liquid crystal panel. An under-lighting system or an edge-lighting system is used as the back light unit. In an under-lighting system, a light source is disposed just under the liquid crystal panel; whereas in an edge-lighting system, a light source is disposed at a side surface of a light guide plate.

Recently, edge-lighting systems have been more frequently used because they reduce a size of the liquid crystal display device. In the edge-lighting system with the light source disposed at the side surface of the light guide plate, the light guide plate uniformly emits light from an emission surface, and the light illuminates the liquid crystal panel. Thus, an edge-lighting system is also called a “surface light source unit”.

In such a surface light source unit, the light guide plate is formed from a planar transparent member such as an acrylic resin plate or the like. Light beams emitted from a light source, such as a cold cathode fluorescent lamp (CCFL) or a light emitting diode (LED), are transmitted through a side surface (light incidence surface) into the light guide plate. All the incident light beams are internally reflected in the light guide plate between a light emission surface and a bottom surface of the light guide plate, and then transmitted out through the light guide plate. A plurality of light reflection dots having a light scattering function is formed on the bottom surface, to increase the uniformity of illumination provided by the light guide plate.

FIG. 8 shows a conventional surface light source unit 20. The surface light source unit 20 includes a plurality of LEDs 210 used as light source, and a light guide plate 22 having a light incidence surface 240, a bottom surface 220 and an emission surface (not visible). A plurality of diffusion dots (not shown) is provided on the bottom surface 220. The diffusion dots are arranged such that the area density thereof increases with increasing distance away from the light source, in order to make the amount of light emitted at the emission surface uniform. However, each LED 210 emits light beams into the light guide plate 22 within a limited range of angles only. The light beams generally cover only a limited area within the light guide plate 22. As a result, a number of remaining areas outside the limited areas covered are so-called dark regions 230, with few light beams entering thereinto. The amount of light reaching the bottom surface 220 at the dark regions 230 is insufficient. It is therefore difficult to provide even brightness throughout the entire emission surface of the light guide plate 22.

In order to solve the above-described problems, various measures have been undertaken. These include increasing the number of LEDs, or increasing a distance between the light source and the light guide plate. Although uniform illumination can be achieved by such measures, it is achieved only by increasing the cost or the size of the surface light source unit.

Therefore, a surface light source unit that overcomes the above-mentioned problems is desired.

### SUMMARY OF THE INVENTION

An object of the present invention is to provide a surface light source unit with highly uniform illumination for a liquid crystal display.

To achieve the above object, a surface light source unit of the present invention includes a plurality of point light sources and a light guide plate. The light guide plate includes a light incidence surface adjacent to the point light sources, a top emission surface perpendicular to the light incidence surface, a bottom surface opposite to the emission surface, and a plurality of side surfaces. A plurality of diffusion dots is formed on the bottom surface, and a plurality of scatter enhancing regions is defined on the bottom surface.

The scatter enhancing regions are located at parts of the bottom surface close to the light incidence surface. The scatter enhancing regions are each generally triangular, with one side of the triangle located adjacent to the light incident surface. A part of the bottom surface not including the scatter enhancing regions is defined as a main region of the bottom surface. The diffusion dots in the main region progressively increase in size with increasing distance away from the point light sources. The diffusion dots in the scatter enhancing regions are larger than the diffusion dots in the main region that are adjacent to the scatter enhancing regions.

The provision of the scatter enhancing regions makes it possible to effectively emit light beams through parts of the emission surface corresponding to the scatter enhancing regions. That is, the surface light source unit of the present invention provides highly uniform illumination.

Other objects, advantages, and novel features of the present invention will become more apparent from the following detailed description when taken in conjunction with the accompanying drawings, in which:

### BRIEF DESCRIPTION OF THE DRAWINGS

FIG. 1 is a simplified, bottom elevation of a preferred first embodiment of the surface light source unit according to the present invention;

FIG. 2 is a front elevation of a light guide plate of the surface light source unit of FIG. 1;

FIG. 3 is a right side elevation of the light guide plate of FIG. 1;

FIG. 4 is a simplified, bottom elevation of a preferred second embodiment of the surface light source unit according to the present invention;

FIG. 5 is a front elevation of a light guide plate of the surface light source unit of FIG. 4;

FIG. 6 is a right side elevation of the light guide plate of FIG. 4;

FIG. 7 is a front elevation of a light guide plate of a preferred third embodiment of the surface light source unit according to the present invention; and

FIG. 8 is a schematic bottom elevation of a conventional surface light source unit.

### DETAILED DESCRIPTION OF THE INVENTION

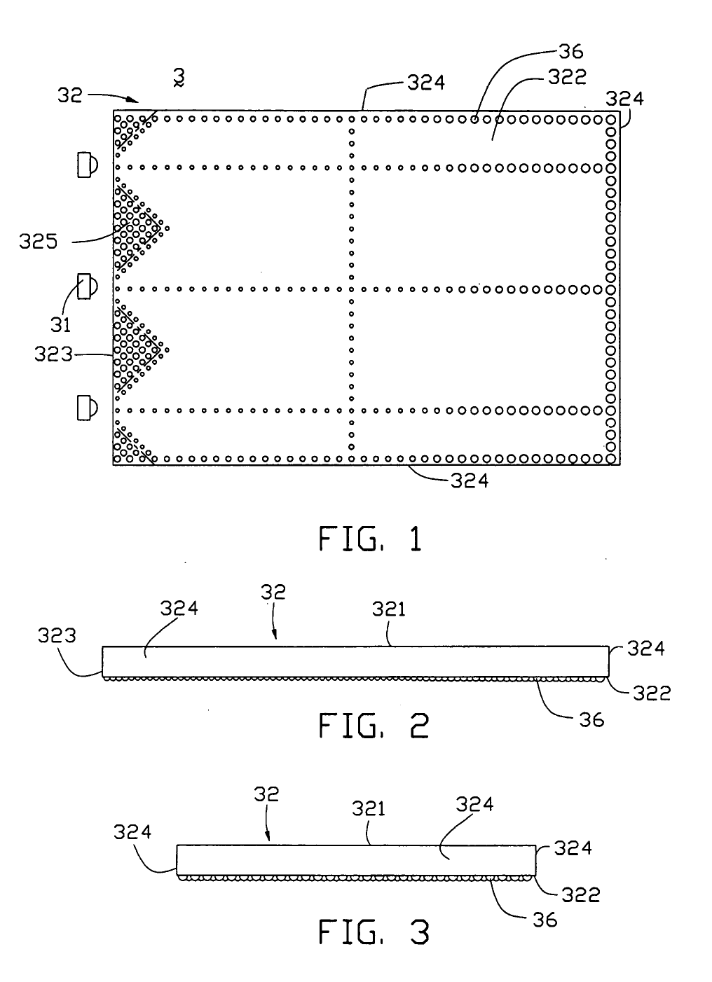

FIGS. 1, 2 and 3 are views of the first embodiment of the surface light source unit of the present invention. FIG. 1 shows a bottom elevation of a surface light source unit 3, which comprises a plurality of point light sources 31 arranged in a line and a light guide plate 32 used to transmit light received from the point light sources 31. The point light sources 31 can be light emitting diodes (LEDs) or like apparatuses. Each point light source 31 emits light beams into the light guide plate 32 within a limited range of angles only. The light beams generally cover only a limited area within the light guide plate 32.

The light guide plate 32 is rectangular, and comprises a light incidence surface 323 adjacent to the point light sources 31, a top emission surface 321 perpendicular to the light incidence surface 323, a bottom surface 322 opposite to the emission surface 321, and a plurality of side surfaces 324. A plurality of diffusion dots 36 is formed on the bottom surface 322. A plurality of scatter enhancing regions 325 is defined on the bottom surface 322, corresponding to areas outside the limited areas covered by the above-described light beams. That is, the scatter enhancing regions 325 are adjacent to the light incident surface 323. A thickness of the light guide plate 32 is preferably in the range from approximately 1 millimeter to 10 millimeters.

Transparent glass or synthetic resin may be used to make the light guide plate 32. Various kinds of highly transparent synthetic resins may be used, such as acrylic resin, polycarbonate resin, vinyl chloride resin, etc. The selected resin may be molded into a plate using known molding methods such as extrusion molding, injection molding, or the like. In particular, polymethyl methacrylate (PMMA) resin provides excellent light transmission, heat resistance, dynamic characteristics, molding performance, processing performance, etc. It is especially suitable as a material for the light guide plate 32.

The diffusion dots 36 are arranged on the bottom surface 322 in a generally uniform array of rows and columns. The diffusion dots 36 in each row thereof are arranged alternately with respect to the diffusion dots 36 in each adjacent row thereof. Similarly, the diffusion dots 36 in each column thereof are arranged alternately with respect to the diffusion dots 36 in each adjacent column thereof. The scatter enhancing regions 325 are each generally triangular, with one side of the triangle located adjacent to the light incident surface 323. Apart of the bottom surface 322 not including the scatter enhancing regions 325 is defined as a main region (not labeled) of the bottom surface 322. The diffusion dots 36 in the main region progressively increase in size with increasing distance away from the point light sources 31, in order to make the light beams emit uniformly from the emission surface 321. Alternatively, the diffusion dots 325 in the main region may be configured to be both uniform in size and greater in number, which achieves the same uniformity of light beam emission from the emission surface 321. The diffusion dots 36 in the scatter enhancing regions 325 are larger than the diffusion dots 36 in the main region that are adjacent to the scatter enhancing regions 325. A distribution density of the diffusion dots 36 in the scatter enhancing regions 325 is preferably in the range from 50% to 90%. A distribution density of the diffusion dots 36 in the main region is preferably in the range from 3% to 85%. Said distribution densities enable light beams to be uniformly emitted from the emission surface 321.

In the preferred first embodiment, the diffusion dots 325 are generally hemispherical. That is, a profile of each diffusion dot 325 is circular. Alternatively, the profile of each diffusion dot 325 may be elliptical, rectangular, rhombic or triangular. The diffusion dots 325 can be made by a screen printing technique, which uses a pale or white ink containing a white pigment such as titanium oxide. The diffusion dots 325 can also be made by a mechanical shot blasting technique, a photo-sensing method using sensitized paper, an integral molding technique, or any other appropriate known method.

The point light sources 31 are disposed adjacent to the light incident surface 323. In operation, the point light sources 31 emit light beams into the light guide plate 32. One portion of the incident light beams is diffused by the diffusion dots 36 and emitted through the emission surface 321. A remaining portion of the light beams is emitted from the bottom surface 322 to an outside of the light guide plate 32, where said light beams are reflected by a reflective plate (not shown) provided on the bottom surface 322 back into the light guide plate 32. The diffusion dots 325 scatter the light beams.

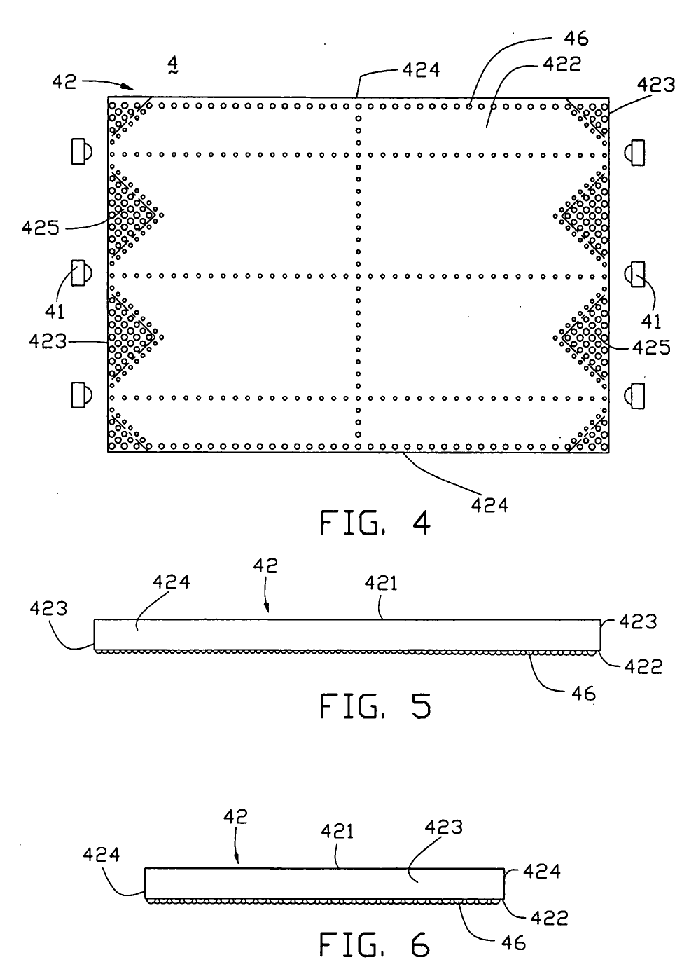

FIGS. 4, 5 and 6 are views of the second embodiment of the surface light source unit of the present invention. The surface light source unit 4 is similar to the surface light source unit 3 of the first embodiment. The surface light source unit 4 comprises a light guide plate 42 having two opposite light incident surfaces 423 and an emission surface 421, and a plurality of point light sources 41 arranged in two lines. The point light sources 41 are provided adjacent to the light incident surfaces 423. A plurality of scatter enhancing regions 425 is defined on a bottom surface 422 adjacent to the light incident surfaces 423. A plurality of diffusion dots 46 is formed on the bottom surface 422. The diffusion dots 46 are arranged in a generally uniform array of rows and columns. The diffusion dots 46 in each of half-portions of a main region of the bottom surface 422 progressively increase in size with increasing distance away from the corresponding point light sources 41. Accordingly, the largest diffusion dots 46 of the main region are located in a center thereof. The diffusion dots 46 in the scatter enhancing regions 425 are larger than the diffusion dots 46 in the main region that are adjacent to the scatter enhancing regions 425.

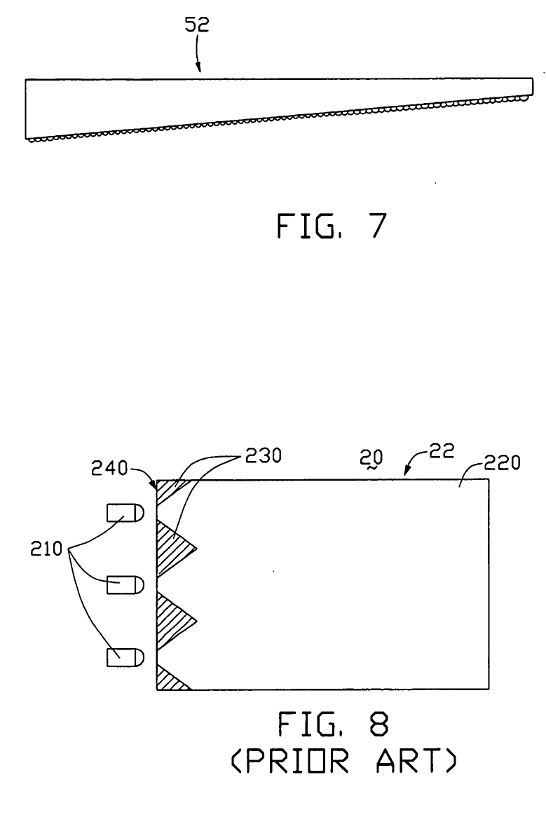

FIG. 7 is a front view of a light guide plate 52 of the third embodiment of the surface light source unit according to the present invention. The light guide plate 52 is wedge-shaped.

The surface light source unit according to the present invention has the following advantages. The provision of the scatter enhancing regions 325, 425 makes it possible to effectively emit light beams through parts of the emission surface 321, 421 corresponding to the scatter enhancing regions 325, 425. Unlike the conventional surface light source unit 20 shown in FIG. 8, there are no apparent dark regions in the light guide plate 32, 42, 52. That is, the surface light source unit of the present invention provides highly uniform illumination.

In order to provide the surface light source unit of the present invention with even more uniform illumination, a diffusing plate or a prism plate can be disposed on the emission surface 321, 421.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A surface light source unit comprising:
a plurality of light sources for emitting light beams; and
a light guide plate for transmitting the light beams, comprising:
a light incidence surface for receiving the light beams;
an emission surface adjacent to the light incidence surface for emitting the light beams;
a bottom surface opposite to the emission surface; and
a plurality of diffusion dots formed on the bottom surface for scattering the light beams;
wherein a plurality of substantially triangular scatter enhancing regions is defined on the bottom surface adjacent to the light sources, and the diffusion dots in the scatter enhancing regions are larger than the diffusion dots in a remaining region of the bottom surface adjacent to the scatter enhancing regions.

2. The surface light source unit as claimed in claim 1, wherein the diffusion dots are arranged generally uniformly on the bottom surface.

3. The surface light source unit as claimed in claim 1, wherein one side of each of the scatter enhancing regions is adjacent to the light incidence surface.

4. The surface light source unit as claimed in claim 1, wherein the sizes of the diffusion dots in the remaining region of the bottom surface increase with increasing distance away from the light incident surface.

5. The surface light source unit as claimed in claim 1, wherein a distribution density of the diffusion dots in the scatter enhancing regions is in the range from 50% to 90%.

6. The surface light source unit as claimed in claim 1, wherein a distribution density of the diffusion dots in the remaining region of the bottom surface is in the range from 3% to 85%.

7. The surface light source unit as claimed in claim 1, wherein the light guide plate is rectangular.

8. The surface light source unit as claimed in claim 1, wherein the light guide plate is wedge-shaped.

9. The surface light source unit as claimed in claim 1, wherein the light guide plate is made of polymethyl methacrylate (PMMA).

10. The surface light source unit as claimed in claim 1, wherein the light source is a point light source.

11. The surface light source unit as claimed in claim 1, wherein each of the light sources is a light emitting diode (LED).

12. The surface light source unit as claimed in claim 1, further comprising a reflective plate disposed on the bottom surface of the light guide plate.

13. The surface light source unit as claimed in claim 1, further comprising a diffusing plate disposed on the emission surface of the light guide plate.

14. The surface light source unit as claimed in claim 1, further comprises a prism plate disposed on the emission surface of the light guide plate.

15. A surface light source unit comprising:
a plurality of light sources for emitting light beams; and
a light guide plate for transmitting the light beams, comprising:
a light incidence surface for receiving the light beams;
an emission surface adjacent to the light incidence surface for emitting the light beams;
a bottom surface opposite to the emission surface; and
a plurality of diffusion dots formed on the bottom surface for scattering the light beams;
wherein a plurality of substantially triangular scatter enhancing regions is provided on the bottom surface close to the light sources, and a distribution density of the diffusion dots in the scatter enhancing regions is greater than a distribution density of the diffusion dots in a remaining region on the bottom surface adjacent to the scattering enhancing regions.

16. The surface light source unit as claimed in claim 15, wherein one side of each of the scatter enhancing regions is adjacent to the light incidence surface.

17. The surface light source unit as claimed in claim 15, wherein the distribution density of the diffusion dots in the scatter enhancing regions is in the range from 50% to 90%.

18. The surface light source unit as claimed in claim 15, wherein the distribution density of the diffusion dots in the remaining region of the bottom surface is in the range from 3% to 85%.

19. A surface light source unit comprising:
a light guide plate;
a plurality of spot light sources located along one side of said light guide plate, and commonly defining a plurality of brighter areas and a plurality of darker areas in the light guide plate alternatively arranged with each other, the darker areas being essentially arranged adjacent to said light sources along said side and being of a diverging configuration away from said side;
a plurality of diffusion dots formed on a bottom face of the light guide plate under a condition that the dot located in the brighter area and closer to the corresponding light source is smaller than dot which is in the same area while far away from the same corresponding light source, and the dot located in the darker area is larger than the dot which is located in the brighter and closer to the corresponding light source.
